(19) United States
(12) Patent Application Publication
(10) Pub. No.: US 2012/0242211 A1
(43) Pub. Date: Sep. 27, 2012

(54) SUPPORT FRAME AND HOUSING AND SUPPORT ASSEMBLY

(75) Inventor: CHIN-MING CHANG, Tu-Cheng (TW)

(73) Assignee: HON HAI PRECISION INDUSTRY CO., LTD., Tu-Cheng (TW)

(21) Appl. No.: 13/105,817

(22) Filed: May 11, 2011

(30) Foreign Application Priority Data
Mar. 23, 2011 (TW) 100109816

(51) Int. Cl. A47B 96/00; F16M 13/02

(52) U.S. Cl. 312/351.1; 248/224.8

(57) ABSTRACT

A support frame, detachably mounted on a housing defining two restriction holes and an engaging hole, includes a first sidewall, a second sidewall, a bottom wall, an elastic engaging member and two guiding portions. The elastic engaging member and the two guiding portions are formed on an outer surface of the first sidewall. The elastic engaging member is capable of moving between a first position where the elastic engaging member is engaging in the engaging hole, and a second position where the elastic engaging member is disengaged from the engaging hole. When the elastic engaging member is at the first position, each guiding portion is at a third position where each guiding portion is engaged and restricted in a corresponding restriction hole. When the elastic engaging member is at the second position, each guiding portion is capable of moving from the third position to a fourth position.

### BACKGROUND

1. Technical Field

The present disclosure relates to support frames and housings and support assemblies having the support frames and the housings.

2. Description of Related Art

Often, additional equipment is installed for existing facilities such as computer systems. For example, a server system needs an additional power source to power additional extension card(s) installed therein. To install the additional equipment, bolts may be used. However, a screwdriver or wrench is then needed, which is inconvenient.

Therefore, a support frame and a housing and a support assembly which can overcome the limitations described, are needed.

### BRIEF DESCRIPTION OF THE DRAWINGS

FIG. 1 is a schematic view of a support assembly including a support frame, according to a first embodiment.

FIG. 2 is an exploded view of the support assembly of FIG. 1.

FIG. 3 is a cut-away view of the support assembly of FIG. 1, showing the support frame in a first state.

FIG. 4 is similar to FIG. 3, but showing the support frame in a second state.

FIG. 5 is similar to FIG. 4, but showing the support frame in a third state.

FIG. 6 is a schematic view of a support assembly, according to a second embodiment.

FIG. 7 is an exploded view of a support assembly, according to a third embodiment.

### DETAILED DESCRIPTION

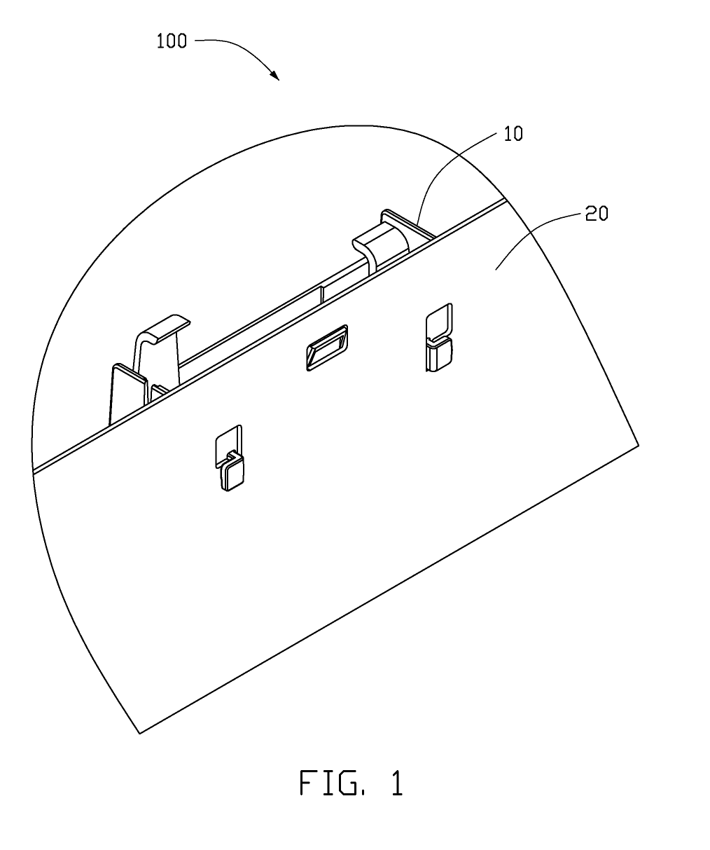

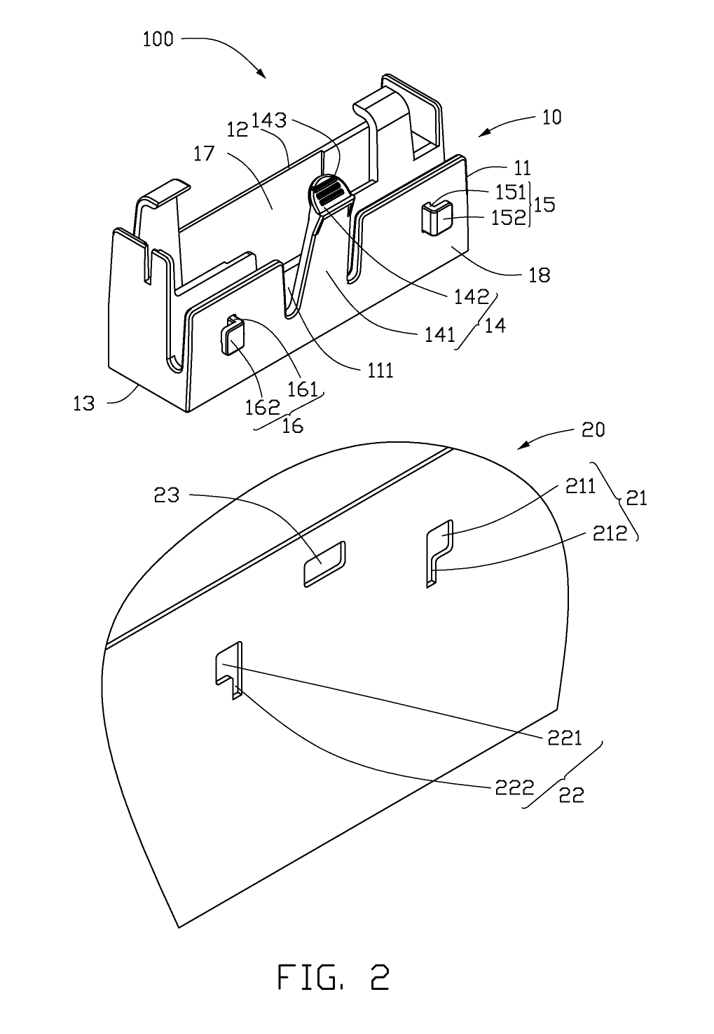

Referring to FIGS. 1 and 2, a support assembly 100, according to a first embodiment, includes a support frame 10 and a housing 20. The support frame 10 is detachably mounted on the housing 20.

The support frame 10 includes a first sidewall 11, a second sidewall 12, a bottom wall 12, an elastic engaging member 14, a first guiding portion 15, and a second guiding portion 16.

The first sidewall 11 opposes the second sidewall 12. The bottom wall 13 connects the first sidewall 11 to the second sidewall 12. The bottom wall 13, the first sidewall 11 and the second side wall 12 cooperatively form a receiving space 17. The receiving space 17 is configured to receive things. A cut-out 111 is defined at a central portion of the first sidewall 11.

The elastic engaging member 14, the first guiding portion 15 and the second guiding portion 16 are formed on an outer surface 18 of the first sidewall 11. The elastic engaging member 14 is arranged between the first guiding portion 15 and the second guiding portion 16.

The elastic guiding member 14 includes an elastic connecting arm 141 and a grab 142 connected to the elastic connecting arm 141. The elastic connecting arm 141 and the grab 142 extend from the outer surface 18 of the first sidewall 11 in that order. In this embodiment, the elastic connecting arm 141 extends from the outer surface 18 of the first sidewall 11 at the cutout 111. An extension direction of the grab 142 from the connecting arm 141 is opposite to that of the connecting arm 141 from the outer surface 18 of the first sidewall 11.

A number of protrusions 143 are formed on the grab 142 to make it easier for a user to grasp and operate the grab 142.

The first guiding portion 15 is substantially L-shaped and includes a guiding arm 151 and an engaging arm 152 connected to the guiding arm 151. The guiding arm 151 and the engaging arm 152 extend from the outer surface 18 in that order. In this embodiment, the guiding arm 151 is substantially perpendicular to the outer surface 18 and the engaging arm 152 is substantially perpendicular to the guiding arm 151.

The second guiding portion 16 is substantially L-shaped and includes a guiding arm 161 and an engaging arm 162 connected to the guiding arm 161. The second guiding portion 16 has a structure similar to that of the first guiding portion 15. An extension direction of the engaging arm 162 from the guiding arm 161 is opposite to that of the engaging arm 152 from the guiding arm 151. The first guiding portion 15 and the second guiding portion 16 are in a mirror image configuration relative to each other.

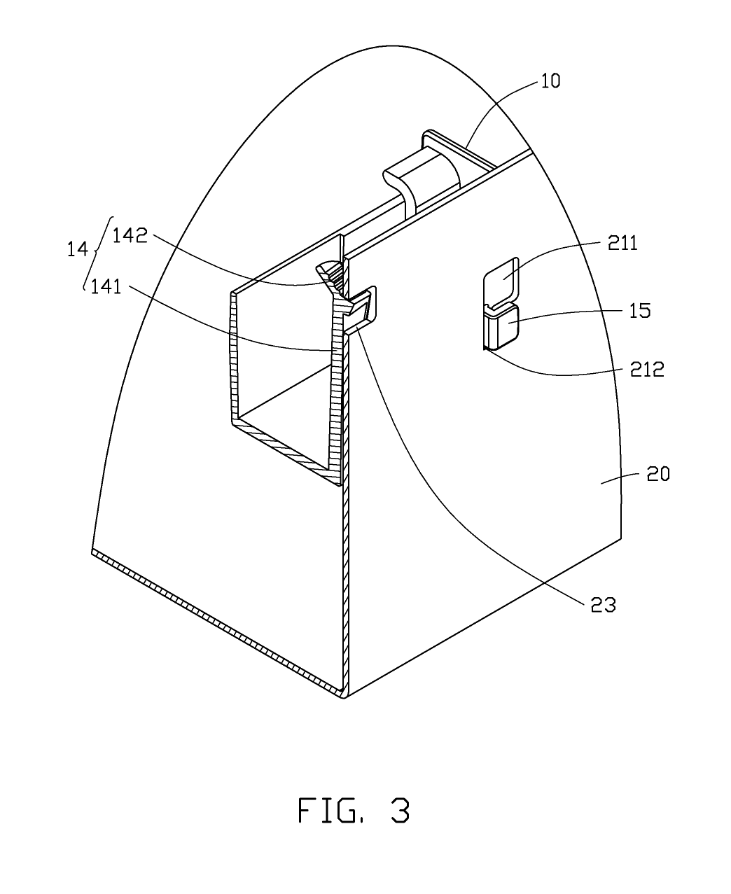

The housing 20 defines a first restriction hole 21, a second restriction hole 22 and an engaging hole 23. The engaging hole 23 is arranged between the first restriction hole 21 and the second restriction hole 22. The first restriction hole 21, the engaging hole 23, and the second restriction hole 22 are arranged in a triangular fashion. The engaging hole 23 is substantially cuboid. The elastic connecting arm 141 and the grab 142 respectively abut upper and lower sides of the engaging hole 23, so that the elastic engaging member 14 engages in the engaging hole 23. As shown in FIG. 3, the elastic engaging member 14 is at a first position where it engages in the engaging hole 23.

The first restriction hole 21 receives and restricts the first guiding portion 15. The first restriction hole 21 includes a guiding-in hole portion 211 and a guiding hole portion 212 in communication with the guiding-in hole portion 211. An area of the guiding-in hole portion 211 is slightly greater than an area of the first guiding portion 15 orthogonally projected on the housing 20 so that the first guiding portion 15 is capable of extending through the guiding-in hole portion 211. The guiding arm 151 is engaged in the guiding hole portion 212.

Structures of the second restriction hole 22 are similar to those of the first restriction hole 21. In this embodiment, the first restriction hole 21 and the second restriction hole 22 are in a mirror image configuration relative to each other. The guiding arm 161 of the second guiding portion 16 is engaged in a guiding hole portion 222 of the second restriction hole 22. Therefore, the support frame 10 is secured on the housing 20 without using bolts and screwdrivers.

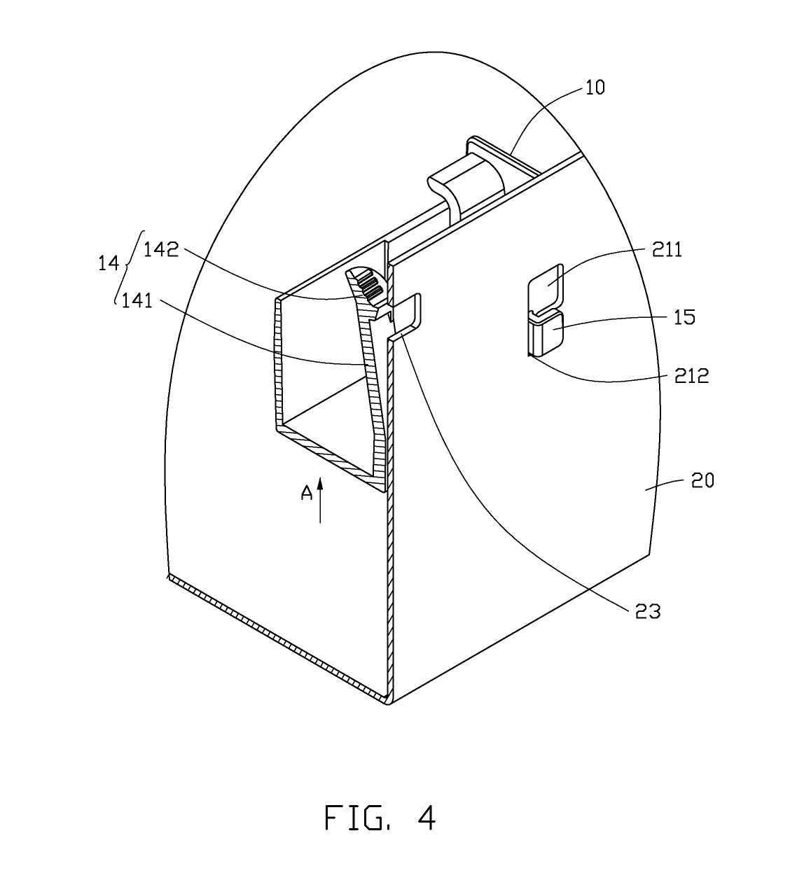

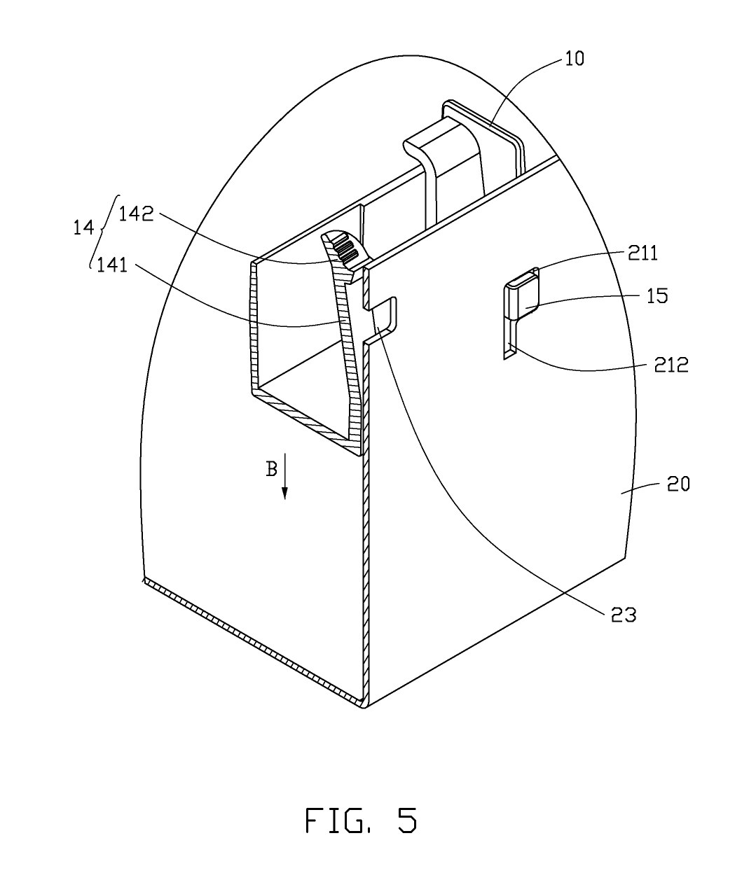

Referring to FIGS. 4 and 5, when detaching the support frame 10 from the housing 20, a user (not shown) operates the grab 142 to move the elastic connecting arm 141 away from the housing 20. When the elastic engaging member 14 is totally disengaged from the engaging hole 23 (see FIG. 4, the elastic engaging member 14 is at a second position where the engaging member 14 is capable of moving freely), the user moves the support frame 10 upwards (such as moving along a direction A in FIG. 4) to make the guiding arms 151, 161 to move from the guiding hole portions 212, 222 to the guiding-in hole portions 211, 221 respectively (FIG. 5 shows the first guiding portion 15 in a position where the first guiding portion 15 is capable of moving out of the first restriction hole 21, and so is the second guiding portion 16). Then, the user moves the support frame 10 away from the housing 20 to make the engaging arms 152, 162 disengaged from the guiding-in hole portions 211, 221 respectively so that the support frame 10 is detached from the housing 20.

When attaching the support frame 10 to the housing 20, the guiding portions 15, 16 are aligned with the guiding-in hole portions 211, 221 respectively. Then the support frame 10 is moved towards the housing 20 to extend the guiding portions 15, 16 through the guiding-in hole portions 211, 221, respectively. If needed, the user may flex the grab 142 away from the housing 20 to allow the grab 142 to more easily enter the engaging hole 23.

Then, the support frame 10 is moved downwards to make the guiding arms 151, 161 engaged in the guiding hole portions 212, 222 respectively. Meanwhile, the elastic engaging member 14 is engaged in the engaging hole 23. The elastic connecting arm 141 and the grab 142 abut the upper and lower sides of the engaging hole 23, respectively and the first guiding portion 15 is restricted in the first restriction hole 21 and the second guiding portion 16 is restricted in the second restriction hole 22. Therefore, the support frame 10 is secured on the housing 20.

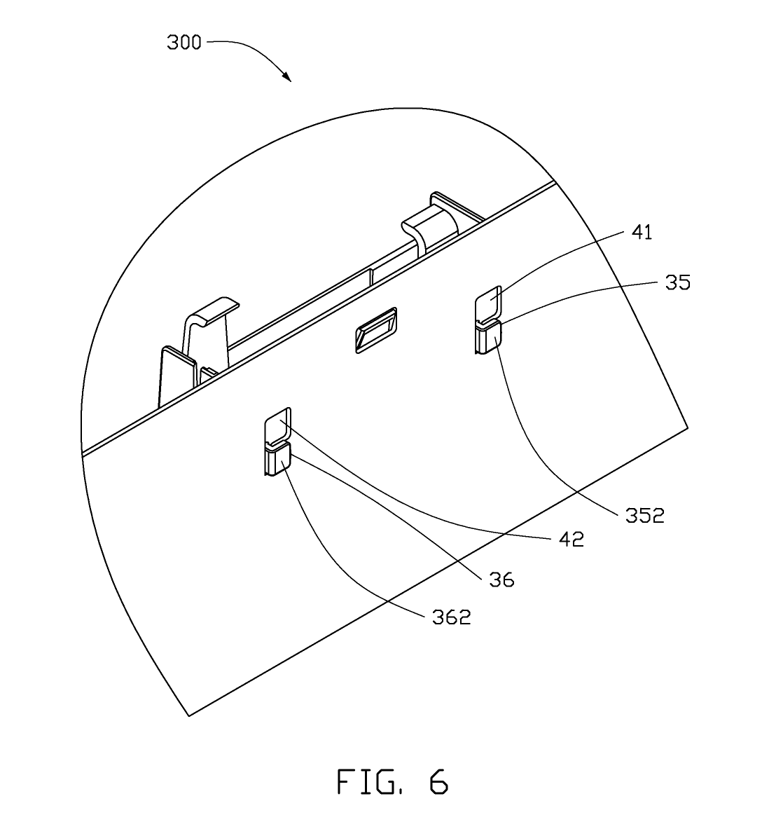

Referring to FIG. 6, a support assembly 300, according to a second embodiment, is shown. The differences between the support assembly 300 and the support assembly 100 of the first embodiment are that an extension direction of an engaging arm 362 of a second guiding portion 36 from a guiding arm 361 is the same as that of an engaging arm 352 of a first guiding portion 35 from a guiding arm 351, and correspondingly, shape of a second restriction hole 42 is the same as that of a first restriction hole 41.

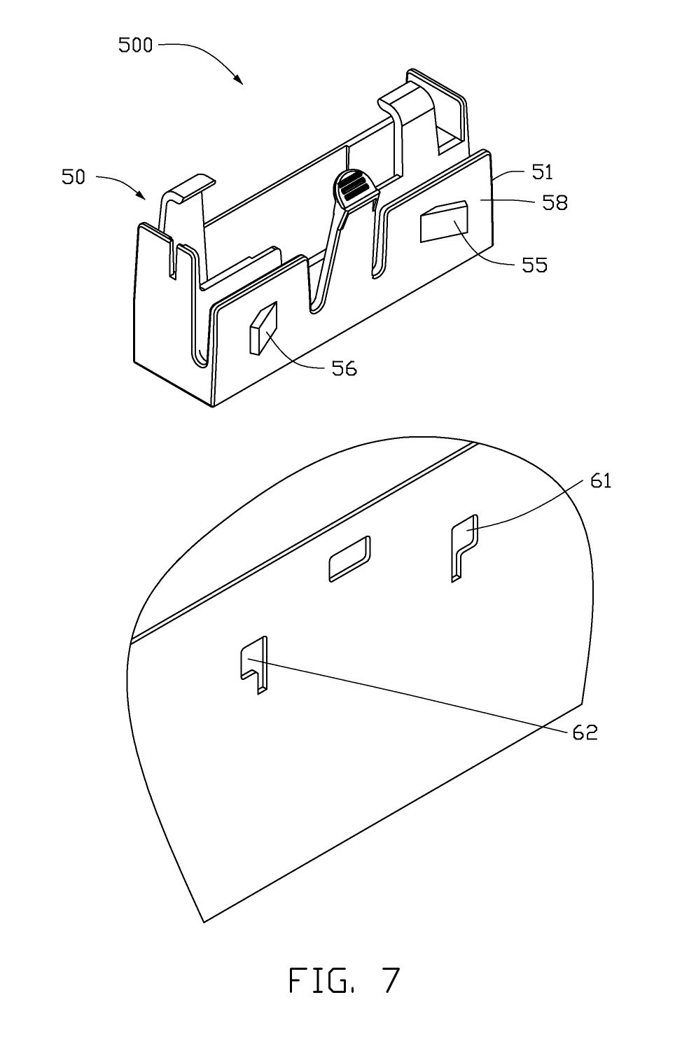

Referring to FIG. 7, a support assembly 500, according to a third embodiment, is shown. The differences between the support assembly 500 and the support assembly 100 of the first embodiment, are that a first guiding portion 55 and a second guiding portion 56 are two plates in a mirror image configuration relative to each other on an outer surface 58 of a first sidewall 51 of a support frame 50. It is to be understood that in alternative embodiments, the first and second guiding portions 55, 56 may be shaped differently, such as cylindrical, as long as the first and second guiding portions 55, 56 are capable of being engaged and restricted in corresponding first and second restriction holes 61, 62.

Advantages of the support assemblies 300, 500 of the second and third embodiments are similar to those of the support assembly 100 of the first embodiment.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A support frame configured to be detachably mounted on a housing, the housing defining two restriction holes and an engaging hole between the two restriction holes, the support frame comprising:
a first sidewall,
a second sidewall,
a bottom wall,
an elastic engaging member, and
two guiding portions, the bottom wall connecting the first sidewall to the second sidewall, the bottom wall, the first sidewall and the second sidewall cooperatively forming a receiving space, the elastic engaging member and the two guiding portions being formed on an outer surface of the first sidewall, the elastic engaging member being arranged between the two guiding portions and capable of moving between a first position where the elastic engaging member is engaged in the engaging hole, and a second position where the elastic engaging member disengaged from the engaging hole, when the elastic engaging member is at the first position, each guiding portion is at a third position where each guiding portion is engaged and restricted in a corresponding restriction hole, and when the elastic engaging member is at the second position, each guiding portion is capable of moving from the third position to a fourth position where each guiding portion is capable of being disengaged from the corresponding restriction hole.

2. The support frame of claim 1, wherein each guiding portion comprises a guiding arm extending from the outer surface and an engaging arm connected to the guiding arm, the engaging arms extending from the respective guiding arms in opposite directions.

3. The support frame of claim 1, wherein the two guiding portions are in a mirror image configuration relative to each other.

4. The support frame of claim 1, wherein the elastic engaging member comprises an elastic connecting arm extending from the outer surface and a grab connected to the elastic connecting arm.

5. The support frame of claim 1, wherein each guiding portion comprises a guiding arm extending from the outer surface and an engaging arm connected to the guiding arm, the engaging arms extending from the respective guiding arms in a same direction.

6. A housing for being coupled to a support frame of claim 1, the housing defining two restriction holes and an engaging hole between the two restriction holes, the engaging hole configured to engagably receive the elastic engaging member, each restriction hole being configured to engage and restrict a corresponding guiding portion and comprising a guiding-in hole portion and a guiding hole portion in communication with the guiding-in hole portion, the guiding-in hole portion configured to guide each guiding portion to move to the fourth position, the guiding hole portion configured to guide each guiding portion to move from the third position to the fourth position.

7. A support assembly, comprising a support frame and a housing, the housing defining two restriction holes and an engaging hole between the two restriction holes, the support frame comprising:
a first sidewall,
a second sidewall,
a bottom wall,
an elastic engaging member, and
two guiding portions, the bottom wall connecting the first sidewall to the second sidewall, the bottom wall, the first sidewall and the second sidewall cooperatively forming a receiving space, the elastic engaging member and the two guiding portions being formed on an outer surface of the first sidewall, the elastic engaging member being arranged between the two guiding portions and capable of moving between a first position where the elastic engaging member is engaged in the engaging hole, and a second position where the elastic engaging member disengaged from the engaging hole, when the elastic engaging member is at the first position, each guiding portion is at a third position where each guiding portion is engaged and restricted in a corresponding restriction hole, and when the elastic engaging member is at the second position, each guiding portion is capable of moving from the third position to a fourth position where each guiding portion is capable of being disengaged from the corresponding restriction hole, each restriction hole comprising a guiding-in hole portion and a guiding hole portion in communication with the guiding-in hole portion, the guiding-in hole portion configured to guide each guiding portion to move to the fourth position, the guiding hole portion configured to guide each guiding portion to move from the third position to the fourth position.

8. The support assembly of claim 7, wherein each guiding portion comprises a guiding arm extending from the outer surface and an engaging arm connected to the guiding arm, the engaging arms extending from the respective guiding arms in opposite directions.

9. The support assembly of claim 7, wherein the two guiding portions are in a mirror image configuration relative to each other.

10. The support assembly of claim 7, wherein the elastic engaging member comprises an elastic connecting arm extending from the outer surface and a grab connected to the elastic connecting arm.

11. The support assembly of claim 7, wherein each guiding portion comprises a guiding arm extending from the outer surface and an engaging arm connected to the guiding arm, the engaging arms extending from the respective guiding arms in a same direction.
